(19) United States
(12) Patent Application Publication
(10) Pub. No.: US 2004/0190475 A1
(43) Pub. Date: Sep. 30, 2004

(54) Moment decision for packet data transmission based on analysis of power control commands

(76) Inventors: Jyri Hamalainen, Oulu (FI); Juha Ylitalo, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/488,265

(22) PCT Filed: Sep. 4, 2002
(86) PCT No.: PCT/FI02/00712

(30) Foreign Application Priority Data
Sep. 5, 2001 (FI) 20011762

(51) Int. Cl. H04B 7/216; H04L 12/26

(52) U.S. Cl. 370/335; 455/522; 370/252

(57) ABSTRACT

The invention relates to a method for transmitting packet data in a radio system, the radio system comprising at least one base station and at least one subscriber terminal and a downlink power control arrangement, in which power control arrangement the quality of a signal transmitted by the base station is evaluated and, on the basis of this evaluation, power control commands are transmitted to the base station. The method comprises analysing (302) the power control commands received by the base station, searching (304) for one or more transmission moments, on the basis of the analysis, that satisfy the set conditions for packet-switched data transmission, and if at least one transmission moment is found that satisfies the set conditions, transmitting (306) packet data to at least one subscriber terminal at least at one transmission moment that satisfies the set conditions.

### FIELD

The invention relates to a method, an arrangement and a base station for transmitting packet data in a radio system, the radio system comprising at least one base station and at least one subscriber terminal and a downlink power control arrangement, in which power control arrangement the quality of a signal transmitted by the base station is evaluated and, on the basis of this evaluation, power control commands are transmitted to the base station.

### BACKGROUND

Requirements set for the data transmission capacity of radio systems are getting higher and higher. A need has arisen to provide a solution for the data transmission capacity required by fast and demanding data transmission, such as the Internet connections. One solution is packet data transmission. In the packet transmission, data to be transmitted is formed into packets that will be transmitted, when there is transmission capacity in the radio network; thus, transmission is discontinuous in nature. Packet transmission is enhanced in WCDMA (Wide Band Code Division Multiple Access) systems due to the HSDPA (High Speed Downlink Packet Access) standard. In GSM (Global Systems for Mobile Communications) systems, the so-called generation 2.5 HSCSD (High-Speed Circuit-Switched Data) and GPRS (General Packet Radio Services) technologies enable the packet transmission.

The packet transmission has a problem that large amounts of data are transmitted within a short period of time. If the transmission fails, for instance due to a fading radio channel, it may be necessary to retransmit the corrupted packets, which decreases the actual transmission capacity and increases interference in a radio cell. Hence, the efficacy of the packet transmission depends largely on the quality of the radio channel during transmission. Currently, attempts have been made to solve this problem such that a receiving user equipment determines a downlink fading rate or Doppler spectrum and notifies a base station of possible packet transmission moments, of which the base station selects a required number of suitable ones. This solution, in turn, has a problem that uplink signalling increases and consequently network loading and interference caused to other users. In addition, the user equipment software becomes more complex and a need for memory space grows.

### BRIEF DESCRIPTION

The object of the invention is to provide an improved method and an improved device. An aspect of the invention is a method for transmitting packet data in a radio system, the radio system comprising at least one base station and at least one subscriber terminal as well as a downlink power control arrangement, in which power control arrangement the quality of a signal transmitted by the base station is evaluated and power control commands are transmitted to the base station on the basis of said evaluation. The method comprises analysing the power control commands received by the base station, searching, on the basis of the analysis, for one or more transmission moments that satisfy the set conditions for packet-switched data transmission, and, if at least one transmission moment is found that satisfies the set conditions, transmitting packet data to at least one subscriber terminal at least at one transmission moment that satisfies the set conditions.

An aspect of the invention is a method for transmitting packet data in a radio system, the radio system comprising at least one base station and at least one subscriber terminal as well as a downlink power control arrangement, in which power control arrangement the quality of a signal transmitted by the base station is evaluated and power control commands are transmitted to the base station on the basis of said evaluation. The method comprises analysing the power control commands received by the base station, searching, on the basis of the analysis, for one or more transmission moments that satisfy the set conditions for packet-switched data transmission, and, if at least one transmission moment is found that satisfies the set conditions, determining duration of the transmission, transmitting packet data to at least one subscriber terminal at least at one transmission moment that satisfies the set conditions, for the determined duration of transmission.

An aspect of the invention is an arrangement for transmitting packet data in a radio system, the radio system comprising at least one base station and at least one subscriber terminal as well as a downlink power control arrangement, in which power control arrangement the quality of a signal transmitted by the base-station is evaluated and power control commands are transmitted to the base station on the basis of said evaluation. The arrangement comprises means for analysing the power control commands received by the base station, the arrangement comprises means for searching, on the basis of the analysis, for one or more transmission moments that satisfy the set conditions for packet-switched data transmission, the arrangement comprises means for transmitting packet data to at least one subscriber terminal at least at one transmission moment that satisfies the set conditions.

An aspect of the invention is an arrangement for transmitting packet data in a radio system, the radio system comprising at least one base station and at least one subscriber terminal as well as a downlink power control arrangement, in which power control arrangement the quality of a signal transmitted by the base station is evaluated and power control commands are transmitted to the base station on the basis of said evaluation. The arrangement comprises means for analysing the power control commands received by the base station, the arrangement comprises means for searching, on the basis of the analysis, for one or more transmission moments that satisfy the set conditions for packet-switched data transmission, the arrangement comprises means for determining the duration of the transmission, the arrangement comprises means for transmitting packet data to at least one subscriber terminal at least at one transmission moment that satisfies the set conditions.

An aspect of the invention is a base station for transmitting packet data in a radio system, the radio system comprising at least one base station and at least one subscriber terminal as well as a downlink power control arrangement, in which power control arrangement the quality of a signal transmitted by the base station is evaluated and power control commands are transmitted to the base station on the basis of said evaluation. The base station comprises means for analysing the received power control commands, the base station comprises means for searching, on the basis of the analysis, for one or more transmission moments that satisfy the set conditions for packet-switched data transmission, the base station comprises means for transmitting packet data to at least one subscriber terminal at least at one transmission moment that satisfies the set conditions.

An aspect of the invention is a base station for transmitting packet data in a radio system, the radio system comprising at least one base station and at least one subscriber terminal as well as a downlink power control arrangement, in which power control arrangement the quality of a signal transmitted by the base station is evaluated and power control commands are transmitted to the base station on the basis of said evaluation. The base station comprises means for analysing the received power control commands, the base station comprises means for searching, on the basis of the analysis, for one or more transmission moments that satisfy the set conditions for packet-switched data transmission, the base station comprises means for determining the duration of the transmission, the base station comprises means for transmitting packet data to at least one subscriber terminal at least at one transmission moment that satisfies the set conditions.

Other preferred embodiments of the invention are disclosed in the dependent claims.

The invention is based on the idea that a user equipment measures a received signal and, on the basis of the measurement results, generates power control commands that are transmitted to a base station for downlink transmission power control. Advantageously, the base station analyses the power control commands and, on the basis of the analysis, determines one or more suitable transmission moments for the packet transmission. According to one embodiment, it is also possible to determine the duration of the transmission.

The invention have advantages, for instance, that the packet transmission being timed for periods when the quality of the radio channel is good, it is possible to transmit the packets with lower transmission power, and consequently interference caused to other users is diminished. It is also more likely that the packet transmission is successful, and so, because there is less need for retransmission, the transmission capacity can be employed more effectively. In addition, there is no need to make the user equipment software more complex, because the implementation of the invention does not necessarily require any changes in the existing user equipments of GSM and WCDMA systems, for instance.

### LIST OF DRAWINGS

In the following the preferred embodiments of the invention will be described by way of example, with reference to the attached drawings, wherein

FIG. 1 is a simplified block diagram of a structure of a radio system;

FIG. 2 is a simplified block diagram of a structure of WCDMA radio system;

FIG. 3 is a flow chart of method steps of transmitting packet data in the radio system;

FIG. 4 shows a measured signal received by a user equipment;

FIG. 5 shows power control commands received by a base station, analysed by integration;

FIG. 6 shows a simplified example of the structure of a base station transceiver as a block diagram;

FIG. 7 shows a simplified example of the structure of a user equipment as a block diagram.

### DESCRIPTION OF THE EMBODIMENTS

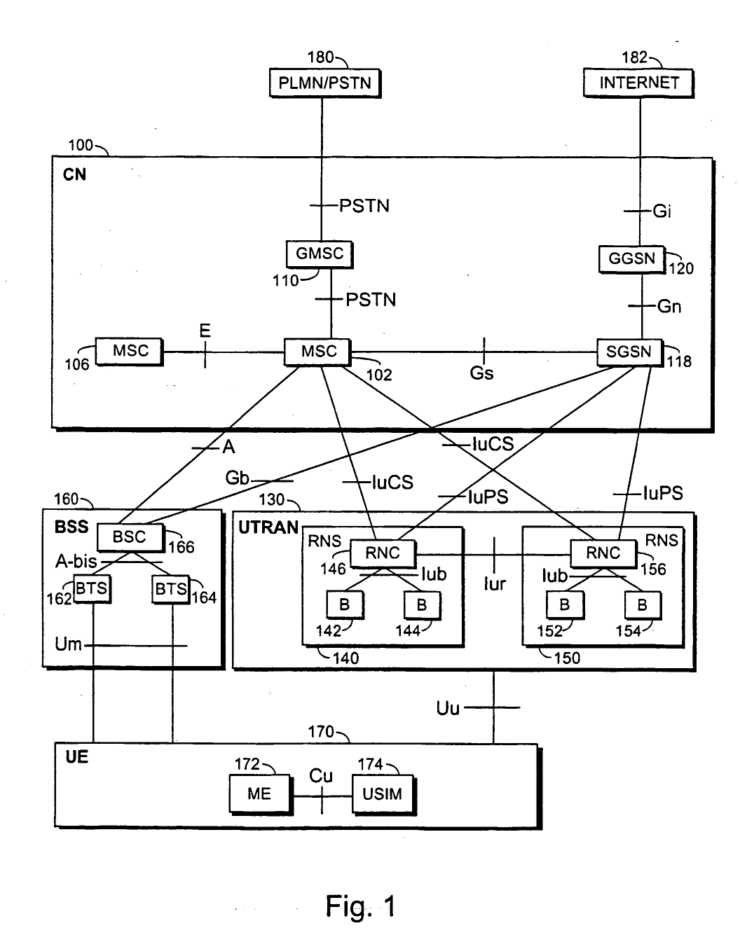

Because the second generation radio systems and the third generation radio systems, as well as various hybrids thereof, i.e. the so-called generation 2.5 radio systems, are already in worldwide use and under continuous development, the embodiments are described in a simplified radio system of FIG. 1, which comprises network elements of different generations side by side. In the description, the second generation radio system is represented by the GSM (Global System for Mobile Communications), the third generation radio system is represented by a radio system based on the GSM and employing EDGE (Enhanced Data Rates for Global Evolution) technology for enhancing data transmission rates, which radio system can also be used for implementing packet transmission in the GPRS (General Packet Radio System). The third generation radio system is also represented by a radio system that is known under names IMT-2000 (International Mobile Telecommunications 2000) and UMTS (Universal Mobile Telecommunications System). However, the embodiments are not restricted to these exemplary systems, but a person skilled in the art may also apply the invention to other radio systems having the required features.

FIG. 1 is a simplified block diagram, which illustrates the most essential parts of the radio system, on the network element level, and the interfaces between them. The structure and functions of the network elements are not described in greater detail, because they are commonly known.

The main parts of the radio system include a core network (CN) 100, a radio access network 130 and a user equipment (UE) 170. UTRAN is short for UMTS Terrestrial Radio Access Network, i.e. the radio access network 130 belongs to the third generation and is implemented by wideband code division multiple access (WCDMA) technology. In addition, FIG. 1 shows a base station system 160, which belongs to the generation 2/2.5 and is implemented by time division multiple access (TDMA) technology.

Generally, it is also possible to define a radio system as follows: a radio system consists of a user equipment, which can also be called a subscriber terminal and a mobile station, and of a network part, which includes the complete fixed infrastructure of the radio system, i.e. a core network, a radio access network and a base station system.

The structure of the core network 100 corresponds to that of the combined GSM and GPRS systems. The GSM network elements take care of the implementation of circuit-switched connections, and the GPRS network element takes care of the implementation of packet-switched connections. However, some of the network elements are included in both systems.

A mobile services switching centre (MSC) 102 is a centre of the core network 100 on the circuit-switched side. The same mobile services switching centre 102 can be used to serve the connections of both the radio access network 130 and the base station system 160. Typically, the mobile services switching centre's 102 tasks include switching, paging, location registration, handover management, collection of subscriber billing information, encryption parameter management, frequency allocation management and echo cancellation.

The number of mobile services switching centres 102 may vary: a small network operator may only have one mobile services switching centre 102, but large core networks 100 may comprise a plurality of them. FIG. 1 shows a second mobile services switching centre 106, but its connections to other network elements are not shown for clarity of FIG. 1.

In large core networks 100 there may be a separate gateway mobile services switching centre (GMSC) 110, which takes care of circuit-switched connections between the core network 100 and external networks 180. The gateway mobile services switching centre 110 is located between the mobile service switching centres 102, 106 and the external networks 180. The external network 180 may be, for instance, a public land mobile network (PLMN) or a public switched telephone network (PSTN).

Typically, the core network 100 also comprises other parts, for instance, a home location register (HLR), which includes a permanent subscriber register and, if the radio system supports GPRS, a PDP (Packet Data Protocol) address and a visitor location register (VLR), which includes roaming information on user equipments 170 in the area of the mobile services switching centre 102. For the sake of clarity, FIG. 1 does not show all the parts of the core network.

A serving GPRS support node (SGSN) 118 is a centre of the core network 100 on the packet-switched side. The main function of the serving GPRS support node is to transmit and receive packets with the user. equipment 170 that supports packet-switched transmission, using the radio access network 130 or the base station system 160. The serving GPRS support node 118 includes subscriber and location information on the user equipment 170.

A gateway GPRS support node (GGSN) 120 is a packet-switched side counterpart of the circuit-switched side gateway mobile services switching centre 110, however, with the difference that the gateway GPRS support node 120 must be able to route outgoing traffic from the core network 100 to the external networks 182, whereas the gateway mobile services switching centre only routes incoming traffic. In the example, the Internet represents the external networks, through which considerable part of the wireless telephone traffic may pass in the future.

The base station system 160 consists of a base station controller (BSC) 166 and base transceiver stations (BTS) 162,164. The base station controller 166 controls the base station 162, 164. In principle, the aim is that the devices that implement the radio path, and the functions related thereto, are located at the base station 162, 164, and the control devices are located in the base station controller 166. Naturally, the implementation may also deviate from this principle.

In general, the base station controller 166 takes care of the following tasks, for instance: radio resource management of the base station 162, 164, intercell handover, frequency management, i.e. frequency allocation to the base stations 162, 164, management of frequency hopping sequences, measurement of time delays in the uplink, operation and maintenance of interface and power control management.

The base station 162,164 includes at least one transceiver, which implements one carrier. In GSM systems, one carrier generally comprises eight time slots, i.e. eight physical channels. One base station 162, 164 may serve one cell or a plurality of sectorized cells. The diameter of the cell may vary from a few metres to tens of kilometres. The base station 162, 164 is often considered to comprise a transcoder, which performs conversion between the speech coding used in the radio system and the speech coding used in the public telephone network. In practice, however, the transcoder is generally physically located in the mobile services switching centre 102. In general, the base stations 162, 164 have the following tasks, for instance: calculation of timing advance (TA), uplink measurements, channel coding, encryption, decryption and frequency hopping.

The radio access network 130 consists of radio network subsystems 140, 150. Each radio network subsystem 140, 150 consists of radio network controllers (RNC) 146, 156 and B nodes 142, 144, 152, 154. The B node is a relatively abstract concept, and therefore the term base station is often used instead of it.

The radio network controller 140, 150 corresponds approximately to the GSM base station controller 166 as regards its functionality, and the B node 142, 144, 152, 154 corresponds to the GSM base station 162, 164. There are also solutions, in which the same device is both the base station and the B node, i.e. said device can implement both the TDMA and the WCDMA radio interfaces at the same time.

The user equipment 170 consists of two parts: a mobile equipment (ME) 172 and a UMTS subscriber identity module (USIM) 174. Naturally the GSM system employs the system-specific identity module. The user equipment 170 comprises at least one transceiver, which implements a radio connection to the radio access network 130 or to the base station system 160. The user equipment 170 may comprise at least two different subscriber identity modules. In addition, the user equipment 170 comprises an antenna, a user interface and a battery. Currently, there is a wide variety of user equipments 170 available, for instance, vehicle-mounted and portable ones. The user equipments 170 are also provided with the same features as personal and portable computers.

USIM 174 comprises user-related data, and in particular, data related to information security, for instance, an encryption algorithm.

Next, interfaces between different network elements shown in FIG. 1 are presented gathered in Table 1. It is apparent to a person skilled in the art that interfaces included in the radio telecommunication system are determined by each particular apparatus implementation and the standard used, and consequently the interfaces of the system may deviate from those of FIG. 1. The most important interfaces in the UMTS include an lu interface between the core network and the radio access network, the lu interface being divided into a circuit-switched interface luCS and a packet-switched interface luPS, and a Uu interface between the radio access network and the user equipment. In the GSM, the most important interfaces include an A interface between the base station controller and the mobile services switching centre, a Gb interface between the base station controller and the serving GPRS support node, and a Um interface between the base station and the user equipment. The interface defines by what kind of messages different network elements can communicate. The objective of the interface standardization is that the network elements of various manufacturers would be able to communicate in the radio system. However, in practice, some of the interfaces are manufacturer-dependent.

TABLE 1

| Interface | between network elements |
|---|---|
| Uu | UE-UTRAN |
| Iu | UTRAN-CN |
| IuCS | UTRAN-MSC |
| IuPS | UTRAN-SGSN |
| Cu | ME-USIM |
| Iur | RNC-RNC |
| Iub | RNC-B |
| A | BSS-MSC |
| Gb | BSC-SGSN |
| A-bis | BSC-BTS |
| Um | BTS-UE |
| E | MSC-MSC |
| Gs | MSC-SGSN |
| PSTN | MSC-GMSC |
| PSTN | GMSC-PLMN/PSTN |
| Gn | SGSN-GGSN |
| Gi | GGSN-INTERNET |

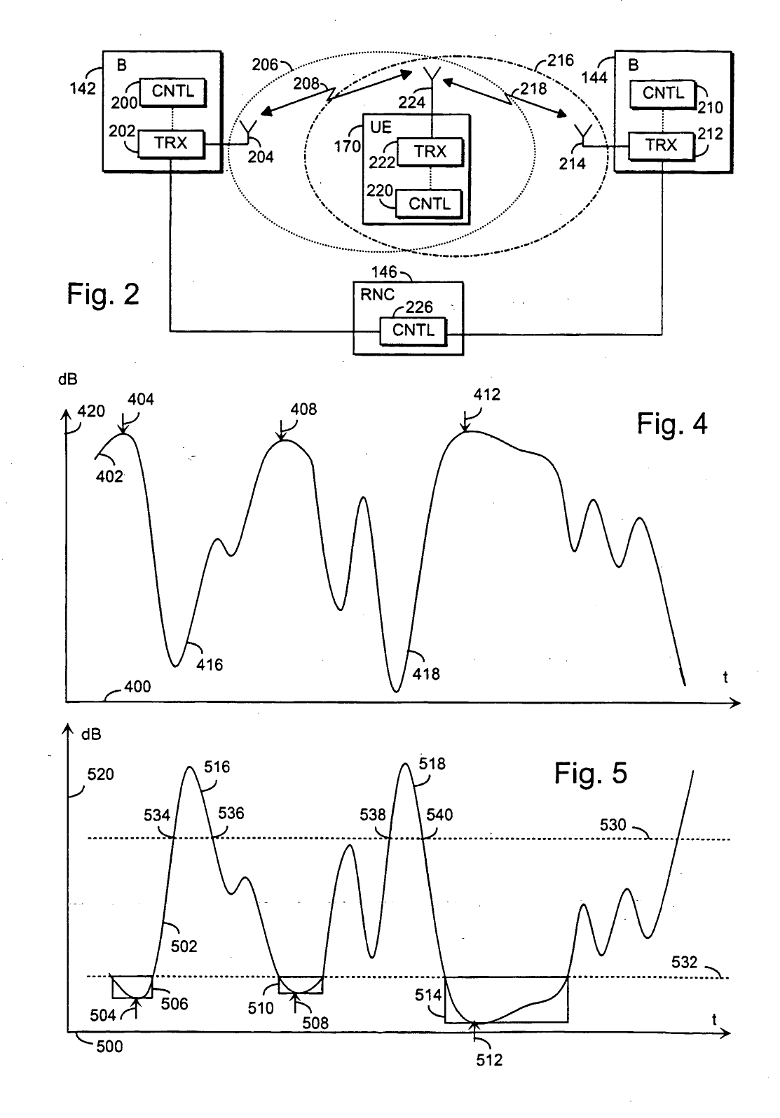

Next, a cellular WCDMA radio telecommunication system is illustrated by means of FIG. 2. FIG. 2 shows part of a simplified radio system, which comprises a subscriber terminal 170, two base stations 142, 144 and a base station controller 146. The first base station 142 comprises a transceiver 202, an antenna 204 and a control block 200. Likewise, the second base station 144 comprises a transceiver 212, an antenna 214 and a control block 210. The base station controller 146 also comprises a control block 226. The user equipment 170 also comprises a conventional transceiver 222 and an antenna 224 for implementing a radio connection, as well as a control block 220. The transceivers 202, 212, 222 employ CDMA (Code Division Multiple Access) technology. In the CDMA technology, the radio resources are allocated to each user by means of user-specific codes. The technology is commonly known, so it is not described in greater detail herein. The antennas 204, 214, 224 can be implemented by conventional, known technology, for instance, as omnidirectional antennas or antennas using a directional antenna beam.

In the radio telecommunication system, the radio cells generated by the base stations generally overlap to some extent in order to provide good coverage. This is illustrated in FIG. 2 by a radio cell 206 generated by the base station 142 and a radio cell 216 generated by the base station 144. In current radio telecommunication systems, wireless telecommunication connections are created such that there is a radio link between the user equipments and the base stations, i.e. the calls or data transmission connections between the different user equipments are created through base stations. Radio links 208, 218 illustrate this in FIG. 2. In particular, FIG. 2 illustrates a situation, where a user equipment 170, which may be mobile, has a radio connection to a first base station 142, for instance, and at the same time it measures common pilot channels of the-first and the second base stations 144 for possible handover. A typical situation is that the radio connection of the user equipment is handed over to the carrier of the second base station, when the new cell has free capacity and the new connection is of better quality. Channel and cell handovers enable the continuity of the radio connection as the user equipment moves or the physical radio channel changes as a function of time.

The control blocks 200, 210, 220, 226 refer to a block that controls the operation of the equipment and that is currently implemented as a processor with software, but various hardware implementations are also possible, for instance a circuit constructed of separate logic components or one or more application-specific integrated circuits (ASIC). Combination of these different implementations is also possible. When selecting the implementation, a person skilled in the art will take into account requirements set for the size and power consumption of the device, necessary processing power, manufacturing costs and production volume.

Literature and standards of the field will provide further information on the radio telecommunication systems.

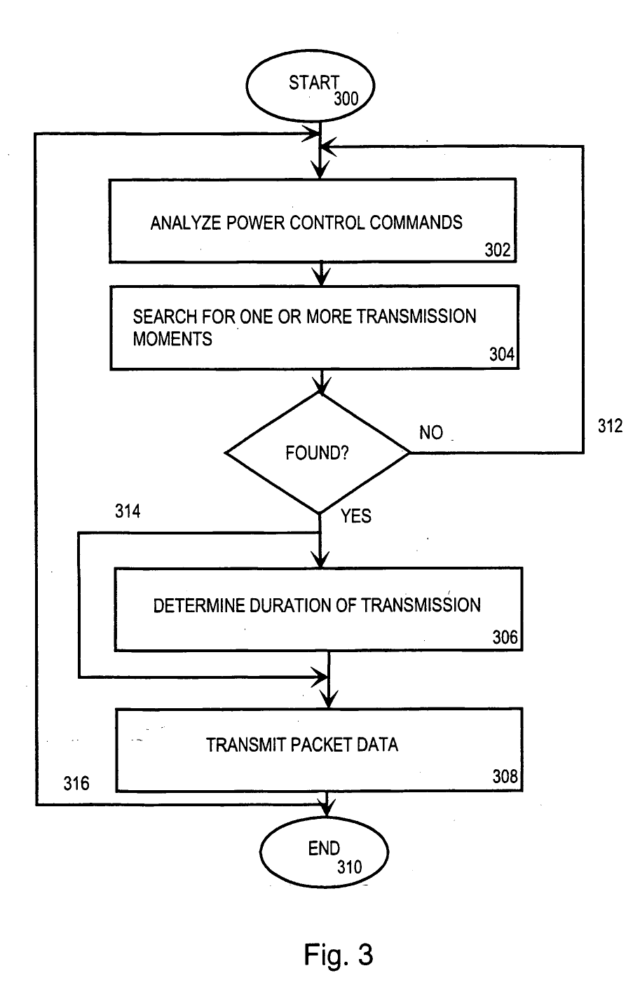

Next, embodiments of the packet data transmission method are described by means of the flow chart of FIG. 3. The radio system to which the method is applied comprises at least one base station and at least one subscriber terminal and a downlink power control arrangement. The objective of the downlink power control arrangement is that the base station performs transmission at the lowest possible power by which the desired quality of signal will be achieved. In general, the power is thus controlled during the entire transmission. Controlling the power in the above-described manner reduces interference caused to other users. The downlink power control arrangements of various radio systems are system-specific and commonly known in the field, and therefore they are not described here in greater detail. However, the power control is typically performed in a simplified manner such that the receiver measures the received signal and on the basis of the measurements gives the sender power control commands, on the basis of which the sender controls its power. In general, it is also possible to ignore the commands in the systems. The signal is measured, for instance, for signal-to-interference ratio (SIR) or bit error rate (BER). Advantageously, the signal to be measured has constant transmission power. Typically, the size of a power control step is arranged to be one decibel, for instance. The sizes of the power control steps may also vary.

In WCDMA systems, the user equipment measures the received common pilot channel (CPICH). If the measurement values do not reach the target level, the user equipment transmits a power control command to the base station, for instance, by FPC (Fast Power Control) bits.

The method starts from block 300. Next, in block 302, power control commands received by the base station are analyzed. The power control commands received by the base station can be analyzed, for instance, by linking the power control commands to suitable values or presentation forms and by comparing the linked values or the presentation forms. For instance, the power control commands can be given numerical values that correspond to the bit combinations, which is clarified next by means of a simplified example. In the example there are four different control commands: large amount of power up, some power up, some power down, large amount of power down. The bit combination 11 refers to large amount of power up, the bit combination 10 refers to some power up, the bit combination 01 refers to some power down and the bit combination 00 refers to large amount of power down. In the base station, the bit combinations can be given numerical values, for instance, as follows: 11 is set to have the numerical value 2, 10 is set to 1, 01 is set to −1 and 00 is set to −2. It is then possible to calculate an average of the numerical values and compare incoming power control commands to the average. The incoming power control commands can also be compared directly with one another.

It is also possible to analyze the power control commands by linking the power control commands to suitable values or presentation forms and by comparing the linked values or presentation forms by integrating. Even in this case, the power control commands can be linked to numerical values in the above-described manner. Integration time can be determined by calculating a variance of previous power control commands so as to find out the variation of the commands. The integration time can also be determined by means of Doppler determination or by simulating the behavior of the radio system. As generally known in the field, the channel fading rate is determined by the DoppIer determination. A Doppler spectrum and an advantageous packet length can be determined in the user eqipment or in the base station and also by means of the power control commands. It is important in the determination of the integration time that the time is suitble in relation to the variation rate of the radio channel: not excessively long, neither excessively short, so as to get as correct impression as possible of the variation of the radio channel.

Next, in block 304 one or more transmission moments that satisfy the set conditions are searched on the basis of the analysis for the packet transmission. This is illustrated in FIGS. 4 and 5.

FIG. 4 shows the power 402 of the received signal, measured by the user equipment, as a function of time. The horizontal axis 400 represents time and the vertical axis 420 represents power in decibels. There are fades 416, 418 and power peaks in the received signal. The most suitable transmission moment for the packet transmission is during one of these power peaks, because successful transmission at a low, i.e. least interfering, power is then likely. Arrows 404, 408, 412 indicate possible transmission moments, perceived by the user equipment.

FIG. 5 shows power control commands received by the base station analyzed by integration, when the power control commands can be represented graphically by means of a high degree curve 502. The power control command curve is a mirror image of the user equipment measurement result curve, but is behind for a time delay resulting from the system. In the figure, the horizontal axis 500 represents time and the vertical axis 520 represents power control commands, for instance, linked to numerical values and analyzed. As appears from the figure, during the maximum fades the user equipment requests the base station to increase its power and the power control command curve shows the peaks 516, 518. Suitable packet transmission moments are those, when the user equipment has given one or more commands to control the power downwardly, usually depending on the channel characteristics and the necessary data transmission capacity.

The possible transmission moments perceived by the base station on the basis of the power control commands are indicated in FIG. 5 by arrows 504, 508, 512. On the basis of the analysis of the power control commands transmitted by the user equipment, performed in block 302, the base station can select one or more transmission moments. Downlink traffic load, number of packets in a transmission queue, scheduling of packets, radio cell loading and quality of the radio channel also contribute to the selection of the transmission moment. If there is a large number of data packets in the transmission queue or the packets are tightly scheduled, it may be necessary to transmit packets also at other transmission moments than the most advantageous ones.

To determine the packet transmission starting moment, it is also possible to utilize setting of a threshold level 530, 532, preferably adaptive, that triggers the transmission. Advantageously, packet transmission starts when the received power measured by the user equipment exceeds the set threshold level, in other words, the results from the analysis of the power control commands received by the base station are below the threshold level. The threshold is preferably adaptive, in order that it can be adapted to changing circumstances. For instance, downlink traffic load, number of packets in a transmission queue, scheduling of packets, radio cell loading and quality of the radio channel contribute to the setting of the threshold level.

In the method, it is also possible to select duration of the packet transmission in block 306, if desired. The duration of the transmission is determined, for instance, by means of the standard packet duration of the system used, measurement data obtained from the channel or a statistical analysis of the power control commands, by which it is possible to evaluate the stability of the radio channel on the basis of the traffic load in the cell, number of packets in the transmission queue and/or the scheduling of the packets. The stability of the radio channel can also be evaluated by simulation or Doppler determination of the channel. For instance, if there is a large number of data packets in the transmission queue or the packets are tightly scheduled, it may be necessary to transmit packets also outside the most preferable transmission window. As appears from FIG. 5, the sizes 506, 510, 514 of the suitable transmission windows may vary as the radio channel changes. Arrow 314 illustrates a possibility to bypass this block, in which case the duration of the packet transmission is determined according to the system standard, for instance.

The curve 502 also allows calculation of a level-crossing rate and an average duration of fades in any manner commonly known in the field, when a threshold level 530 is set. Thus, for instance, the duration of the fades 416, 418 in FIG. 4 can be calculated as a difference between time instants 534, 536 and 538, 540. The derivative of the curve 502 has then turned from positive to negative and the curve 502 exceeds the set threshold level 530. By means of the threshold level 530 and the analysis it is possible to find out the starting moment of the fades and the average length of the fades. In this manner it is possible to find out an advantageous starting moment of the packet data transmission and the duration thereof.

Likewise, by means of the second threshold level 532 indicated in FIG. 5 it is possible to determine moments 504, 508, 512 and windows 506, 510, 514, when the state of channel is most advantageous for the data transmission, i.e. the curve 502 is below the threshold level 531.

Next, in block 308, packet data is transmitted, if a suitable transmission window was found.

The method ends in block 310. The arrow 312 illustrates a situation, where no suitable transmission moment was found, and typically, the search is then reiterated. The arrow 316 illustrates how the method is reiterated when subsequent packets are transmitted.

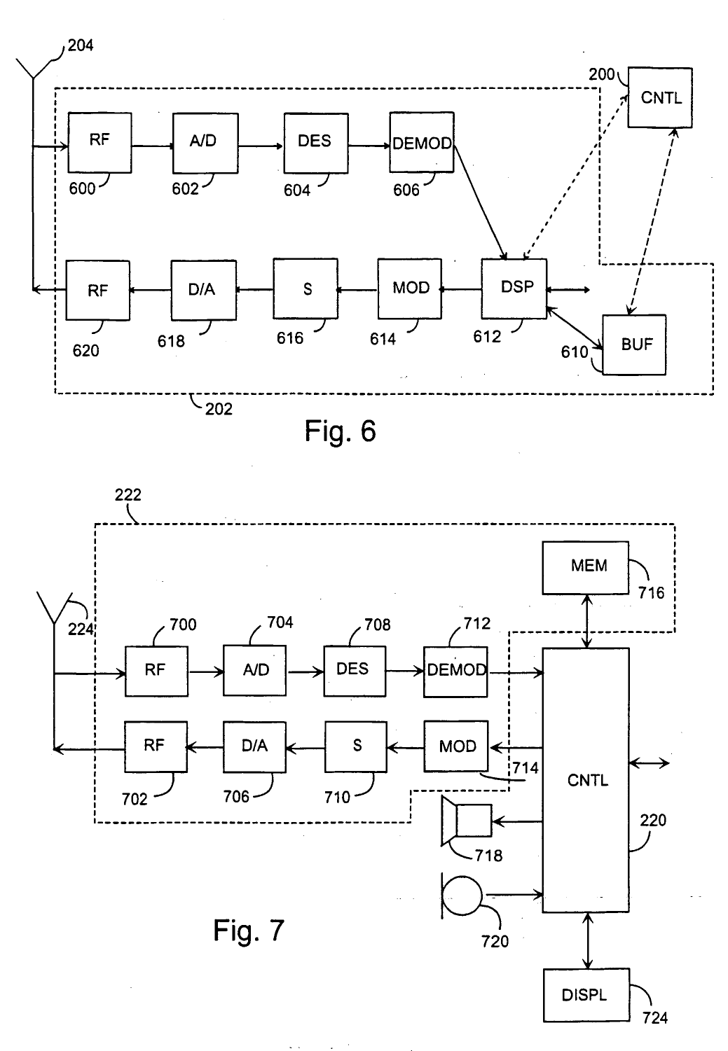

In the following, the invention is described with reference to FIG. 6, which shows, as a block diagram, a simplified example of a base station transceiver according to an embodiment. It is apparent to a person skilled in the art that the transceiver also comprises other parts than those described in connection with FIG. 6.

The transmitter is described by means of blocks 614 to 620 and the receiver by means of blocks 600 to 606. In the example of FIG. 6, the radio parts of the transmitter and of the receiver are described separate, but they may also be combined. A signal processing block 612 represents the device parts of the base station that are required for forming user speech or data in the transmitter. There may be one signal processing block, as in the example of the figure, or one for the transmitter and one for the receiver. Information sequence, i.e. a signal, consisting of symbols, i.e. one or more bits, is processed in the transmitter in various ways. Signal processing, which includes coding, for instance, is generally implemented in a DSP (Digital Signal Processing) processor. If the system employs frame transmission, the frames consisting of time slots, the frame formation, as well as symbol interleaving, are typically performed in the DSP processor. Also the analysis of the power control commands received from the user equipment and the determination of a suitable transmission moment and the duration thereof are performed in this block.

In block 614 the signal is modulated by a desired modulation method. The objective of signal coding and interleaving is to ensure that the transmitted information can be restored in the receiver, even though all the information bits would not have been received. Block 616 represents multiplication by a spreading code, performed on the information to be transmitted in direct-sequence spread spectrum systems, by which multiplication a narrowband signal is spread onto a broad band. Signal conversion from digital to analogue is performed in block 618. In RF parts 620, the signal is up-converted to a selected transmission frequency, amplified and filtered, if necessary. In the example of the figure, the transmitter and the receiver have a common antenna 204, which makes it necessary to have a duplex filter to separate the transmitted and the received signals from one another. The antenna can be a single antenna or an antenna array consisting of a plurality of antenna elements.

The receiver includes RF parts 600, in which the received signal is filtered, down-converted either directly to the base band or to an intermediary frequency, and amplified. In block 602, the signal is converted from analogue to digital by sampling and quantizing, in block 604 the direct sequence broadband signal is assembled by multiplying it by a code sequence generated by a code generator, in block 606 the effect of the carrier is removed from the signal by demodulation and in block 612 is performed the necessary signal processing, such as de-interleaving, decoding and decryption.

Block 610 is a buffer memory, in which received power control commands or data on their analysis can be stored.

In one preferred embodiment, the receiver, such as a RAKE-type, branched receiver, comprises a delay estimator, by which delays of multipath-propagated components are estimated. The delays of different RAKE-branches are set to correspond the delays of variously delayed signal components.

In addition, the base station comprises a control part 200, which in the solution of the present embodiment typically comprises a software program that controls the transmission of packets. Additionally, it controls, in association therewith, storing of power control commands and their analysis for finding a suitable transmission moment and for determining the duration of the transmission.

FIG. 7 illustrates, in a simplified manner, one user equipment in a wireless telecommunication system, such as a cellular radio system, to which the method of the invention can be applied. The terminal can be e.g. a portable telephone or computer, without restricting thereto, however. The described terminal comprises an antenna 224, by which signals are both transmitted and received via a duplex filter. The terminal also comprises the receiver's radio frequency (RF) parts 700, in which the received signal is filtered, amplified and down-converted to a selected intermediate frequency or directly to the base band. The power determination of the received signal can also be carried out in the RF parts. The terminal also comprises an A/D converter 704, which converts the signal from analogue to digital by sampling and quantizing the baseband signal. If the signal is a wideband, direct-sequence signal, it is assembled by multiplying it by a spreading code sequence in block 708. The code generator of the receiver is synchronized with the received signal to be in correct phase. The receiver also comprises a demodulator 712, which demodulates the received signal, in order that a data signal can be distinguished from the carrier. The receiver may also comprise a de-interleaver for undoing the interleaving.

The transmitter part of the terminal comprises a modulator 714, which modulates the carrier with a data signal containing desired information according to a selected modulation method. If the direct-sequence spread spectrum system is concerned, the signal is multiplied by a spreading code sequence in block 710. The objective of the signal spreading onto a broad band is to enhance the interference tolerance of the system and thus to improve the capacity. The signal that is spread with a sufficiently long spreading code resembles white Gaussian noise in the radio channel. The transmitter also comprises a D/A converter 706, which converts the signal from digital to analogue, and RF parts 702, in which the signal to be transmitted is upconverted onto a transmission frequency, amplified to have a sufficient transmission power, and filtered, if necessary. The RF parts of the receiver and the transmitter can also be combined into one RF block.

The terminal also comprises a control part 220, which comprises e.g. control and calculation means for controlling the operation of the different terminal parts and means for processing the user's speech or the data generated by the user, such as a DSP (Digital Signal Processing) processor, which comprises e.g. channel equalizer functions, which compensate for interference caused to the signal by the radio channel, typically utilizing channel data obtained by means of a known training sequence, and encoding and decoding means that carry out both channel and speech coding. In channel coding, systematic bit redundancy, typically parity bits, added to the signal are used for error detection and correction in a decoder. In speech coding, which generally is source coding, unsystematic redundancy appearing in source symbols is typically removed so as to reduce the necessary bit rate. Coding can also be used for encrypting a covering letter or information therein. The control part 220 also comprises means for adapting the transmitted signal and the signaling information to be compatible with the air interface standard of the radio system employed.

The control part 220 also comprises means for forming an opinion on a need for base station transmission power control by means of the received signal and comparison information, such as transmission power informed by the base station, bit error ratios or other data obtained on the radio channel. The control part also generates a power control command on the basis of the need for power control, which command is transmitted to the base station.

The user interface of the terminal comprises a loudspeaker or an earpiece 718, a microphone 720, a display 724 and a keypad, if any, which communicate with the control part. The terminal also comprises a plurality of various memory elements, which are presented as one operational block 716. A memory element comprises, for instance, stored data, such as information on the state of the radio network and the transmission power of the base station. Part of the memory element can also be used as a buffer memory for the display. The memory element also includes a program and subprograms controlling the operation of the terminal. Terminal functions according to the invention, such as determination of the need for base station power control and generation of a power control command, can typically be implemented by means of software, by making the software with the required commands available to the terminal control unit. The invention can also be implemented, for instance, by hardware solutions providing required functionality, for instance as an ASIC (Application Specific Integrated Circuit) or by utilizing separate logic components.

Advantageously, the invention is implemented by means of software, and typically the base station 142, 144 then comprises a microprocessor and the functions of the described method are implemented as software operating therein. It is apparent to a person skilled in the art that the functions of the method for performing packet transmission can also be implemented in a decentralized system, in which case the analysis of the power control commands and the determination of the timing and duration of the transmission are performed in the base station and in a radio network controller. The invention can also be implemented, for instance, by hardware solutions providing required functionality, for instance as an ASIC (Application Specific Integrated Circuit) or by utilizing separate logic components.

Even though the invention is described above with reference to the example of the attached drawings, it is apparent that the invention is not restricted thereto, but it can be modified in a variety of ways within the scope of the inventive idea disclosed in the attached claims.

1. A method for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the method comprising:
characterized by
analyzing (302) the power control commands received by the base station, searching (304) for one or more transmission moments that satisfy the set conditions for the packet transmission, on the basis of the analysis, and if at least one transmission moment that satisfies the set conditions is found
transmitting (308) packet data to at least one subscriber terminal at least at one transmission moment that satisfies the set conditions.

2. A method for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the method comprising:
characterized by
analyzing (302) the power control commands received by the base station, searching (304) for one or more transmission moments that satisfy the set conditions for the packet transmission, on the basis of the analysis, and if at least one transmission moment that satisfies the set conditions is found
determining (306) duration of the transmission,
transmitting (308) packet data for the determined duration of transmission to at least one subscriber terminal at least at one transmission moment that satisfies the set conditions.

3. The [[A]] method as claimed in claim 1 or 2, characterized in that wherein the power control commands are analyzed by linking the power control commands to suitable values or presentation forms and by comparing the linked values or presentation forms.

4. The [[A]] method as claimed in claim 1 or 2, characterized in that wherein the power control commands are analyzed by linking the power control commands to suitable values or presentation forms and by comparing the linked values or presentation forms by integration.

5. The [[A]] method as claimed in claim 1 or 2, characterized in that wherein the search for the transmission moment utilizes setting of an adaptive threshold level that triggers transmission.

6. The [[A]] method as claimed in claim 1 or 2, characterized in that wherein downlink traffic load affects the setting of the threshold level that triggers the transmission.

7. The [[A]] method as claimed in claim 1 or 2, characterized in that wherein the number of packets in a transmission queue affects the setting of the threshold level that triggers the transmission.

8. The [[A]] method as claimed in claim 1 or 2, characterized in that wherein scheduling of packets affects the setting of the threshold level that triggers the transmission.

9. The [[A]] method as claimed in claim 1 or 2, characterized in that wherein radio cell loading affects the setting of the threshold level that triggers the transmission.

10. The [[A]] method as claimed in claim 1 or 2, characterized in that wherein the quality of a radio channel affects the setting of the threshold level that triggers the transmission.

11. The [[A]] method as claimed in claim 1 or 2, characterized in that wherein the duration of the transmission is determined by means of a statistical analysis of the measurement data obtained on a channel.

12. The [[A]] method as claimed in claim 1 or 2, characterized in that wherein the duration of the transmission is determined by means of a statistical analysis of the power control commands.

13. The [[A]] method as claimed in claim 1 or 2, characterized in that wherein the duration of the transmission is determined by means of a Doppler determination.

14. The [[A]] method as claimed in claim 1 or 2, characterized in that wherein a condition for a suitable transmission moment is one or more commands to reduce the transmission power of the base station.

15. The [[A]] method as claimed in claim 1 or 2, characterized in that wherein a condition for a suitable transmission moment is one or more commands to reduce the transmission power of the base station at least for a predetermined amount.

16. An arrangement for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the arrangement comprising:
characterized in that
the arrangement comprises means (200, 610, 612) for analyzing power control commands received by the base station,
the arrangement comprises means (200, 610, 612) for searching for one or more transmission moments that satisfy the set conditions for packet data transmission on the basis of the analysis,
the arrangement comprises means (200, 204, 610, 612, 614, 616, 618, 620) for transmitting packet data to-at least one subscriber terminal at least at one transmission moment that satisfies the set conditions.

17. An arrangement for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the arrangement comprising:
characterized in that
the arrangement comprises means (200, 610, 612) for analyzing power control commands received by the base station,
the arrangement comprises means (200, 610, 612) for searching for one or more transmission moments that satisfy the set conditions for packet data transmission on the basis of the analysis,
the arrangement comprises means (200, 610, 642) for determining duration of the transmission,
the arrangement comprises means (200, 204, 610, 612, 614, 616, 618, 620) for transmitting packet data to at least one subscriber terminal at least at one transmission moment that satisfies the set conditions.

18. The [[An]] arrangement as claimed in claim 16 or 17, characterized in that wherein power control commands are analyzed by linking the power control commands to suitable values or presentation forms and by comparing the linked values or presentation forms.

19. The [[An]] arrangement as claimed in claim 16 or 17, characterized in that wherein power control commands are analyzed by linking the power control commands to suitable values or presentation forms and by comparing the linked values or presentation forms by integration.

20. The [[An]] arrangement as claimed in claim 16 or 17, characterized in that wherein the search for the transmission moment utilizes setting an adaptive threshold level that triggers the transmission.

21. The [[An]] arrangement as claimed in claim 16 or 17, characterized in that wherein downlink traffic load affects the setting of the threshold level that triggers the transmission.

22. The [[An]] arrangement as claimed in claim 16 or 17, characterized in that wherein the number of packets in a transmission queue affects the setting of the threshold level that triggers the transmission.

23. The [[An]] arrangement as claimed in claim 16 or 17, characterized in that wherein scheduling of packets affects the setting of the threshold level that triggers the transmission.

24. The [[An]] arrangement as claimed in claim 16 or 17, characterized in that wherein radio cell loading affects the setting of the threshold level that triggers the transmission.

25. The [[An]] arrangement as claimed in claim 16 or 17, characterized in that wherein the quality of a radio channel affects the setting of the threshold level that triggers the transmission.

26. The [[An]] arrangement as claimed in claim 16 or 17, characterized in that wherein the duration of the transmission is determined by means of a statistical analysis of measurement data obtained on the channel.

27. The [[An]] arrangement as claimed in claim 16 or 17, characterized in that wherein the duration of the transmission is determined by means of a statistical analysis of power control commands.

28. The [[An]] arrangement as claimed in claim 16 or 17, characterized in that wherein the duration of the transmission is determined by means of a Doppler determination of the channel.

29. The [[An]] arrangement as claimed in claim 16 or 17, characterized in that wherein a condition for a suitable transmission moment is one or more commands to reduce the transmission power of the base station.

30. The [[An]] arrangement as claimed in claim 16 or 17, characterized in that wherein a condition for a suitable transmission moment is one or more commands to reduce the transmission power of the base station for at least a predetermined amount.

31. A base station for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the base station comprising:
characterized in that
the base station comprises means (00,610, 612) for analyzing received power control commands,
the base station comprises means (200, 610, 612) for searching for one or more transmission moments that satisfy the set conditions for packet data transmission on the basis of the analysis,
the base station comprises means (200, 204, 610, 612, 614, 616, 618, 620) for transmitting packet data to at least one subscriber terminal at least at one transmission moment that satisfies the set conditions.

32. A base station for transmitting packet data in a radio system, the radio system comprising at least one base station and at least one subscriber terminal, and a downlink power control arrangement, in which power control arrangement the quality of a signal transmitted by the base station is evaluated and power control commands are transmitted to the base station on the basis of this evaluation, the base station comprising:
characterized in that
the base station comprises means (200, 610, 612) for analyzing received power control commands,
the base station comprises means (200, 610, 612) for searching for one or more transmission moments that satisfy the set conditions for packet data transmission on the basis of the analysis,
the base station comprises means (200, 610, 612) for determining duration of the transmission,
the base station comprises means (200, 204, 610, 612, 614, 616, 168, 620) for transmitting packet data to at least one subscriber terminal at least at one transmission moment that satisfies the set conditions.

33. The [[A]] base station as claimed in claim 31 or 32, characterized in that wherein the power control commands are analyzed by linking the power control commands to suitable values or presentation forms and by comparing the linked values or presentation forms.

34. The [[A]] base station as claimed in claim 31 or 32, characterized in that wherein the power control commands are analyzed by linking the power control commands to suitable values or presentation forms and by comparing the linked values or presentation forms by integration.

35. The [[A]] base station as claimed in claim 31 or 32, characterized in that wherein the search for the transmission moment utilizes setting of an adaptive threshold level that triggers the transmission.

36. The [[A]] base station as claimed in claim 31 or 32, characterized in that wherein downlink traffic load affects the setting of the threshold level that triggers the transmission.

37. The [[A]] base station as claimed in claim 31 or 32, characterized in that wherein the number of packets in a transmission queue affects the setting of the threshold level that triggers the transmission.

38. The [[A]] base station as claimed in claim 31 or 32, characterized in that wherein scheduling of packets affects the setting of the threshold level that triggers the transmission.

39. The [[A]] base station as claimed in claim 31 or 32, characterized in that wherein radio cell loading affects the setting of the threshold level that triggers the transmission.

40. The [[A]] base station as claimed in claim 31 or 32, characterized in that wherein the quality of a radio channel affects the setting of the threshold level that triggers the transmission.

41. The [[A]] base station as claimed in claim 31 or 32, characterized in that wherein the duration of the transmission is determined by means of a statistical analysis of measurement data obtained on the channel.

42. The [[A]] base station as claimed in claim 31 or 32, characterized in that wherein the duration of the transmission is determined by means of a statistical analysis of power control commands.

43. The [[A]] base station as claimed in claim 31 or 32, characterized in that wherein the duration of the transmission is determined by means of a Doppler determination of the channel.

44. The [[A]] base station as claimed in claim 31 or 32, characterized in that wherein a condition for a suitable transmission moment is one or more commands to reduce the transmission power of the base station.

45. The [[A]] base station as claimed in claim 31 or 32, characterized in that wherein a condition for a suitable transmission moment is one or more commands to reduce the transmission power of the base station at least for a predetermined amount.
